(19) United States
(12) Patent Application Publication
(10) Pub. No.: US 2026/0210494 A1
(43) Pub. Date: Jul. 23, 2026

(54) CRYOGENIC TANK COMPRISING AT LEAST ONE ANTI-SLOSHING STRUCTURE, AIRCRAFT COMPRISING AT LEAST ONE TANK OF THIS KIND

(71) Applicants: Airbus Operations SAS, TOULOUSE (FR); Airbus Operations Limited, FILTON (GB)

(72) Inventors: Raquel ALONSO CASTILLA, TOULOUSE (FR); Julien GALLARDO, TOULOUSE (FR); Paul D'HULSTER, TOULOUSE (FR); Julien LAVERNE, TOULOUSE (FR); Damien GUILLOTEAU, TOULOUSE (FR); Guillaume JAMBON, FILTON, BRISTOL (GB); Jörg KLATTE, BREMEN (DE); Philipp BEHRUZI, BREMEN (DE)

(21) Appl. No.: 19/451,367

(22) Filed: Jan. 16, 2026

(30) Foreign Application Priority Data
Jan. 20, 2025 (FR) FR2500585

(51) Int. Cl. F17C 1/00

(52) U.S. Cl. CPC F17C 1/00; F17C 2201/0166; F17C 2221/012; F17C 2223/0161; F17C 2260/016; F17C 2270/0189

(57) ABSTRACT

A cryogenic tank with at least one enclosure containing a liquid phase and having at least one anti-sloshing structure formed from walls and positioned inside the enclosure and configured to compartmentalize the enclosure and at least one connection system connecting the anti-sloshing structure and the enclosure. Also an aircraft with at least one such tank.

### CROSS-REFERENCES TO RELATED APPLICATIONS

This application claims the benefit of French Patent Application Number FR2500585 filed on Jan. 20, 2025, the entire disclosure of which is incorporated herein by way of reference.

### FIELD OF THE INVENTION

The present application relates to a cryogenic tank comprising at least one anti-sloshing structure, and to an aircraft comprising at least one tank of this kind.

### BACKGROUND OF THE INVENTION

In one prior-art embodiment, a cryogenic tank comprises an outer enclosure, an inner enclosure positioned within the outer enclosure, thermal insulation between the outer and inner enclosures, and two diametrically opposed connection systems connecting the outer and inner enclosures, at least one of the two connection systems being configured to allow movement of the inner enclosure relative to the outer enclosure. In one configuration, the tank comprises a liquid phase extraction system located in a lower part of the inner enclosure, and a depressurization and/or pressurization system for a gaseous phase located in an upper part of the inner enclosure. This depressurization and/or pressurization system is configured to discharge a portion of the gaseous phase present in the tank in the event of overpressure and/or to inject a gaseous phase into the tank to increase the pressure.

In one mode of operation, the inner enclosure of the tank contains a subcooled liquid hydrogen phase, topped by a gaseous phase. In this case, the liquid phase has a pair of values (temperature and pressure) lying above the hydrogen saturation curve.

When the hydrogen tank is positioned in an aircraft, the liquid present in the cryogenic tank may be subjected, in flight, to sloshing. Due to this sloshing, the liquid will cool the gas, causing a drop in pressure. Consequently, the state of the hydrogen will tend to move closer to the saturation curve, potentially reaching it and thereby causing a change in state of the hydrogen.

According to another issue, this sloshing will cause mixing of the liquid and gaseous phases. Hence, the gaseous phase may contain liquid particles, increasing the risk of malfunction of the depressurization system, and/or the liquid phase may contain bubbles, increasing the risk of malfunction of equipment supplied with hydrogen.

The present invention aims to remedy all or some of the disadvantages of the prior art.

### SUMMARY OF THE INVENTION

To this end, the invention relates to a cryogenic tank comprising at least one enclosure containing a liquid phase and having first, second, and third orthogonal directions, the third direction being vertical.

According to the invention, the cryogenic tank comprises at least one anti-sloshing structure positioned inside the enclosure and at least one connection system connecting the anti-sloshing structure and the enclosure, the anti-sloshing structure comprising first and second series of first and second walls arranged in such a manner as to compartmentalize the enclosure.

Compartmentalizing the enclosure makes it possible to limit excessive movements of the liquid inside the enclosure and to limit the risks of mixing of the gaseous and liquid phases.

According to another feature, the enclosure extends between an upper portion and a lower portion offset along the third direction. In addition, the first and second walls are arranged in such a manner as to define compartments having volumes that decrease toward the upper portion of the enclosure.

According to another feature, the first series of first walls comprises at least four first walls that are substantially perpendicular to the third direction.

According to another feature, each first wall is symmetrical with respect to a vertical median plane, comprises lateral edges positioned on either side of the vertical median plane, and has a transverse profile which, at the vertical median plane, comprises a central region offset downward relative to the lateral edges.

According to another feature, each of the first walls comprises at least one first through-opening and/or a cut-out to allow a flow of liquid from the upper portion toward the lower portion of the enclosure.

According to another feature, the second series of second walls comprises at least four second walls that are substantially perpendicular to the first direction.

According to another feature, at least one second wall comprises at least one second through-opening.

According to another feature, the anti-sloshing structure comprises at least one third wall that is substantially perpendicular to the second direction.

According to another feature, the cryogenic tank comprises at least one sealing system interposed between at least one first wall and the enclosure, limiting a fluid passage between said first wall and the enclosure.

According to another feature, the cryogenic tank comprises at least one piece of equipment dedicated to a gaseous phase, the anti-sloshing structure comprising at least one partition that defines, with the enclosure, an upper region in which the equipment dedicated to a gaseous phase is positioned.

According to another feature, the partition comprises a central portion that is substantially perpendicular to the third direction, and first and second wings, located on either side of the central portion, which form an angle of between 5 and 45° with a plane passing through the central portion.

According to another feature, the partition has a peripheral edge that is spaced apart from the enclosure by a small clearance, the cryogenic tank comprising a peripheral strip which extends over at least a portion of the peripheral edge of the partition, substantially parallel to the partition and spaced a small distance therefrom.

According to another feature, the connection system comprises an elastically deformable element which has a central portion connected to the enclosure, a peripheral ring connected to the anti-sloshing structure, and a plurality of radial blades connecting the central portion and the peripheral ring and allowing the central portion and the peripheral ring to move relative to one another along a displacement direction.

The invention also relates to an aircraft comprising at least one cryogenic tank according to any of the preceding features.

### BRIEF DESCRIPTION OF THE DRAWINGS

Other features and advantages will become apparent from the description of the invention that follows, this description being provided solely by way of example, with reference to the accompanying drawings in which:

FIG. 1 is a schematic representation of a cryogenic tank comprising at least one anti-sloshing device illustrating one embodiment of the invention,

FIG. 2 is a perspective view of a cryogenic tank comprising an anti-sloshing device illustrating one embodiment of the invention,

FIG. 3 is a perspective view of a portion of a cryogenic tank illustrating another embodiment of the invention,

FIG. 4 is a schematic transverse sectional view of a cryogenic tank illustrating another embodiment of the invention,

FIG. 5 is a schematic transverse sectional view of a cryogenic tank illustrating another embodiment of the invention,

FIG. 6 is a perspective view of an anti-sloshing device illustrating various details of the invention,

FIG. 7 is a schematic transverse sectional view of a cryogenic tank illustrating another embodiment of the invention,

FIG. 8 is a schematic transverse sectional view of a cryogenic tank illustrating another embodiment of the invention,

FIG. 9 is a schematic transverse sectional view of a cryogenic tank illustrating another embodiment of the invention,

FIG. 10 is a perspective view of a connection system connecting an anti-sloshing device and an enclosure of a cryogenic tank illustrating one embodiment of the invention,

FIG. 11 is a transverse sectional view of the connection system shown in FIG. 10, and,

FIG. 12 is a schematic of the assembly process for the connection system shown in FIG. 10.

### DETAILED DESCRIPTION OF THE PREFERRED EMBODIMENTS

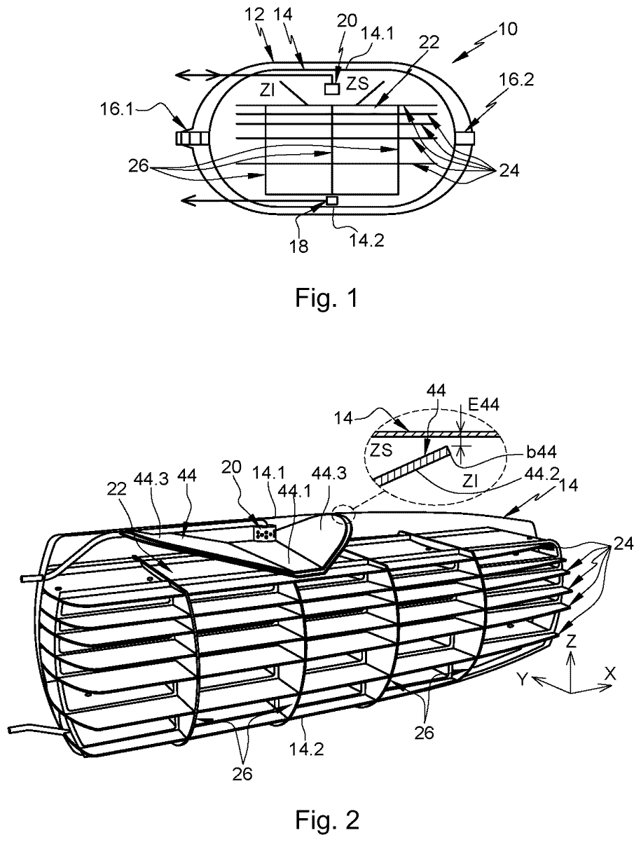

According to one embodiment shown in FIG. 1, a cryogenic tank 10 comprises an outer enclosure 12, an inner enclosure 14 positioned in the outer enclosure 12, thermal insulation between the outer and inner enclosures 12, 14, and two diametrically opposed connection systems 16.1, 16.2 connecting the outer and inner enclosures 12, 14, at least one of the two connection systems 16.1, 16.2 being configured to allow movement of the inner enclosure 14 relative to the outer enclosure 12.

According to one configuration that can be seen in FIG. 1, the cryogenic tank 10 comprises a liquid phase extraction system 18 located in a lower part of the inner enclosure 14, and a depressurization and/or pressurization system 20 for a gaseous phase located in an upper part of the inner enclosure 14.

In a variant, the cryogenic tank 10 comprises only a single enclosure 14, as illustrated in FIG. 2.

According to one application, an aircraft comprises at least one cryogenic tank 10 storing hydrogen in a subcooled state.

Of course, the invention is not limited to this application. Whatever the mode of operation, the cryogenic tank 10 comprises at least one enclosure 14 containing a liquid phase. This enclosure 14 has a first direction X that is substantially (i.e., +/−10%) horizontal when the cryogenic tank 10 is positioned in an aircraft on the ground, a second direction Y that is perpendicular to the first direction X and substantially horizontal when the cryogenic tank 10 is positioned in an aircraft on the ground, and a third direction Z that is perpendicular to the first and second directions X, Y and substantially vertical when the cryogenic tank 10 is positioned in an aircraft on the ground. The first direction X extends along the greatest dimension of the enclosure 14 of the cryogenic tank 10. The first, second, and third directions X, Y, Z are three orthogonal directions. The enclosure 14 extends between an upper portion 14.1 and a lower portion 14.2 offset along the third direction Z.

According to one configuration, the cryogenic tank 10 is symmetrical with respect to a vertical median plane VMP, parallel to the first and third directions X, Z.

The cryogenic tank 10 comprises at least one anti-sloshing structure 22 positioned inside the enclosure 14.

According to one embodiment, the anti-sloshing structure 22 comprises at least first and second series of first and second walls 24, 26, the first walls 24 of the first series being approximately perpendicular to the third direction Z, and the second walls 26 of the second series being substantially perpendicular to the first direction X.

The first and second walls 24, 26 make it possible to compartmentalize the enclosure 14 along the first and second directions X and Z corresponding to the greatest dimension of the cryogenic tank 10 and to the vertical direction, which makes it possible to mitigate the effects of sloshing. In a preferred arrangement, the first and second walls 24, 26 are arranged in such a manner that the volumes of the compartments delimited by the first and second walls 24, 26 decrease toward the upper portion 14.1. This arrangement makes it possible to optimize the operation of the anti-sloshing structure 22.

In a preferred configuration, the first series comprises at least four first walls 24. The first walls 24 are spaced apart from one another by a first spacing that varies along the third direction Z, the first walls 24 being closer together near the upper portion 14.1 than near the lower portion 14.2.

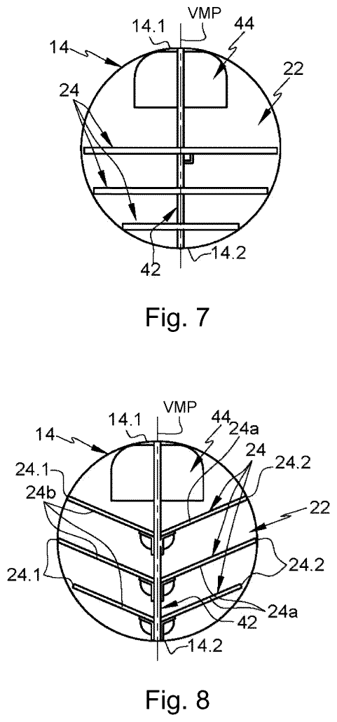

According to a first configuration that can be seen in FIG. 7, at least one of the first walls 24 is planar. All of the first walls 24 are preferably planar.

According to a second configuration that can be seen in FIG. 8, at least one of the first walls 24 has, in a transverse plane (perpendicular to the first direction X), a V-shape that is symmetrical with respect to the vertical median plane VMP, said V-shape having two branches 24a, 24b, the tip of the V-shape being oriented toward the lower portion 14.2. All of the first walls 24 preferably have a V-shape.

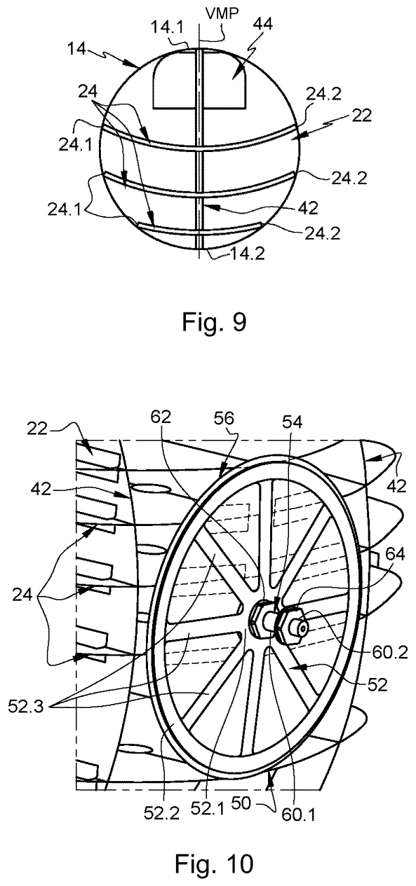

According to a third configuration that can be seen in FIG. 9, at least one of the first walls 24 has, in a transverse plane (perpendicular to the first direction X), a curved shape that is symmetrical with respect to the vertical median plane VMP, said curved shape being concave. All of the first walls 24 preferably have a concave curved shape.

In the last two configurations that can be seen in FIGS. 8 and 9, each first wall 24 is symmetrical with respect to a vertical median plane VMP, comprises lateral edges 24.1, 24.2 positioned on either side of the vertical median plane VMP, and has a transverse profile that comprises a central region, at the vertical median plane VMP, offset downward relative to the lateral edges 24.1, 24.2.

According to one embodiment that can be seen in FIG. 6, at least one first wall 24 has at least one first through-opening 28, preferably several first through-openings 28. In a preferred embodiment, the various first walls 24 each have at least one first through-opening 28 to allow a flow of liquid from the upper portion 14.1 toward the lower portion 14.2 of the enclosure 14. The first through-openings 28 of the various first walls 24 are offset from one first wall 24 to another, so as not to promote the flow of the liquid from top to bottom.

Each of the first walls 24 has first and second lateral edges 24.1, 24.2 that are symmetrical with respect to the vertical median plane VMP. At least one of the first and second lateral edges 24.1, 24.2 of at least one first wall 24 is spaced apart by a first clearance J24, as illustrated in FIG. 4.

According to one configuration, each first wall 24 has a peripheral edge that is slightly spaced apart from the enclosure 14.

According to one embodiment, the cryogenic tank 10 comprises at least one sealing system 30 interposed between at least one of the first and second lateral edges 24.1, 24.2 of at least one first wall 24 and the enclosure 14, limiting a fluid passage between said first wall 24 and the enclosure 14.

According to a first embodiment that can be seen in FIG. 4, for at least one of the first and second lateral edges 24.1, 24.2 of at least one first wall 24, the sealing system 30 comprises a blade 32 fastened to the enclosure 14, substantially parallel to said first wall 24 and slightly spaced apart from said first wall 24, said blade 32 having a width greater than the first clearance J24. The blade 32 has a length (dimension taken along the first direction X) that is substantially equal to that of the first wall 24. The first wall 24 and the blade 32 are arranged in such a manner that a leak path is generated. In a preferred arrangement, the cryogenic tank 10 comprises at least one blade 32 for at least one first or second lateral edge 24.1, 24.2 of each first wall 24. Each blade 32 may extend over the entire length of the associated first wall 24 or comprise several sections placed end to end or slightly spaced apart from one another.

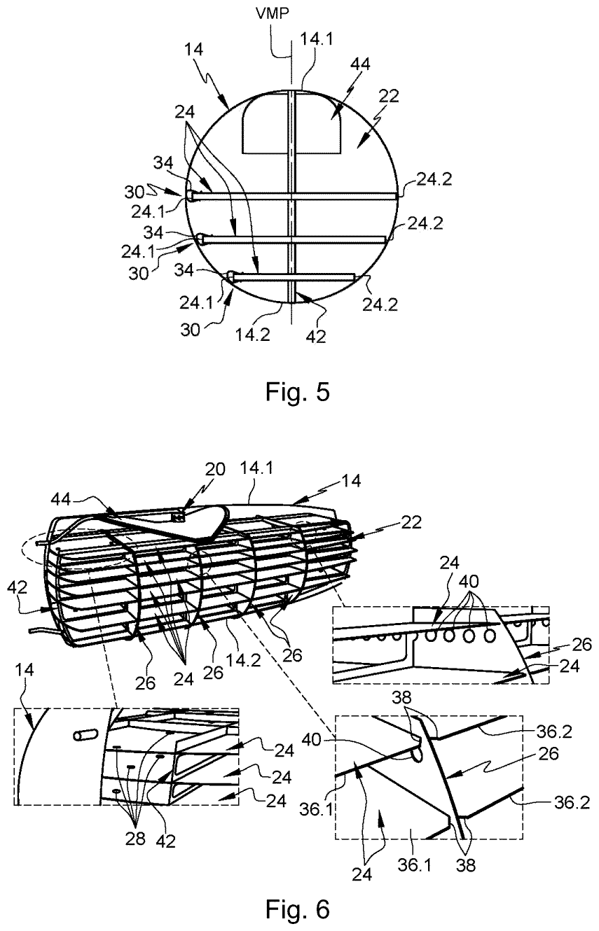

According to a second embodiment that can be seen in FIG. 5, for at least one of the first and second lateral edges 24.1, 24.2 of at least one first wall 24, the sealing system 30 comprises a C-shaped angle section 34 fitted onto the first or second lateral edge 24.1, 24.2, said C-shaped angle section 34 being in contact with the enclosure 14 in use when the enclosure 14 contracts under the effect of the cryogenic temperature of the hydrogen that it contains. The C-shaped angle section 34 generally has a length (dimension taken along the first direction X) that is substantially equal to that of the first wall 24. In a preferred arrangement, the cryogenic tank 10 comprises at least one C-shaped angle section 34 for at least one first or second lateral edge 24.1, 24.2 of each first wall 24. Each C-shaped angle section 34 may extend over the entire length of the associated first wall 24 or comprise several sections placed end to end or slightly spaced apart from one another.

Of course, the invention is not limited to these two embodiments for the sealing system 30 provided between a first wall 24 and the enclosure 14. Furthermore, one and the same cryogenic tank 10 may comprise different sealing systems 30.

In one configuration, each of the first walls 24 may be produced in a single piece. In another configuration that can be seen in FIG. 6, at least one first wall 24 is produced in several parts 36.1, 36.2, each of which extends between two second walls 26 or between a second wall 26 and the enclosure 14.

According to one embodiment that can be seen in FIG. 6, at least one first wall 24 comprises at least one cut-out 38 in a junction region between a second wall 26 and a first or second lateral edge 24.1, 24.2. This cut-out 38 allows a liquid to flow from the upper portion 14.1 toward the lower portion 14.2 of the enclosure 14.

In a preferred configuration, the second series of second walls 26 comprises at least four second walls 26. According to one embodiment, at least one second wall 26 is substantially planar. All of the second walls 26 are preferably planar. Each of the second walls 26 may be produced in a single piece or in several parts.

At least one second wall 26 comprises at least one second through-opening 40. In one configuration, the second through-openings 40 are located between the three first walls 24 closest to the upper portion 14.1 of the enclosure 14. These through-openings 40 allow gaseous hydrogen to pass so as to prevent gaseous hydrogen from becoming trapped beneath hydrogen in the liquid state.

In one configuration, each second wall 26 has a peripheral edge that is spaced apart from the enclosure 14 by a small clearance, at least over a portion located below the first wall 24 that is closest to the upper portion 14.1 of the enclosure 14.

In a preferred embodiment, the anti-sloshing structure 22 comprises at least one third wall 42 that is substantially perpendicular to the second direction Y and to the first and second walls 24, 26. In one embodiment that can be seen in FIGS. 4, 5, 7, 8, and 9, the anti-sloshing structure 22 comprises a single third wall 42 positioned at the vertical median plane VMP, as illustrated in FIGS. 4 and 5. In another embodiment that can be seen in FIG. 10, the anti-sloshing structure 22 comprises at least two third walls 42 positioned symmetrically with respect to the vertical median plane VMP.

Associated with the first and second walls 24, 26, this (or these) third wall(s) makes (make) it possible to increase the compartmentalization of the enclosure 14 and to improve the structural strength of the anti-sloshing structure.

In one configuration, each third wall 42 has a peripheral edge that is slightly spaced apart from the enclosure 14, at least over a portion located below the first wall 24 closest to the upper portion 14.1 of the enclosure 14.

In an embodiment that can be seen more particularly in FIGS. 2, 3, and 6, the cryogenic tank 10 comprises at least one partition 44 which, together with the enclosure 14, delimits an upper region ZS in which at least one piece of equipment dedicated to a gaseous phase is positioned, such as the depressurization and/or pressurization system 20, for example. This partition 44 separates the upper region ZS from a lower region ZI in which at least one piece of equipment dedicated to a liquid phase is positioned, said partition 44 enabling mixing of the liquid and gaseous phases to be prevented, the gaseous phase being substantially present in the upper region ZS and the liquid phase being present in the lower region ZI. In particular, said equipment dedicated to the liquid phase is located in a lower part of the enclosure 14 and corresponds to a system for extracting the liquid phase toward equipment supplied with hydrogen.

This partition 44 makes it possible to prevent liquid from being drawn in by the depressurization and/or pressurization system 20.

In one configuration, this partition 44 comprises a central portion 44.1 that is substantially perpendicular to the third direction Z, located close to the first wall 24 situated near the upper portion 14.1 or coinciding with this first wall 24, and first and second wings 44.2, 44.3 located on either side of the central portion 44.1. The central portion 44.1 and the first and second wings 44.2, 44.3 are each substantially planar. In one arrangement, each of the first and second wings 44.2, 44.3 forms an angle of between 5 and 45° with a plane passing through the central portion 44.1. The first and second wings 44.2, 44.3 are substantially symmetrical with respect to a transverse plane perpendicular to the first direction X. The angles of each of the first and second wings 44.2, 44.3 are selected in such a manner that one corresponds to a maximum tilt angle of the aircraft and the other to a minimum tilt angle of the aircraft. The partition 44 thereby prevents any mixing of the liquid and gaseous phases.

The partition 44 has a peripheral edge b44 that is spaced apart from the enclosure by a clearance E44, as illustrated in FIG. 2. This clearance E44 allows the stresses induced by the anti-sloshing structure 22 on the enclosure 14 to be limited. However, this clearance E44 must be as small as possible, in order to limit the passage of the liquid phase into the upper region ZS.

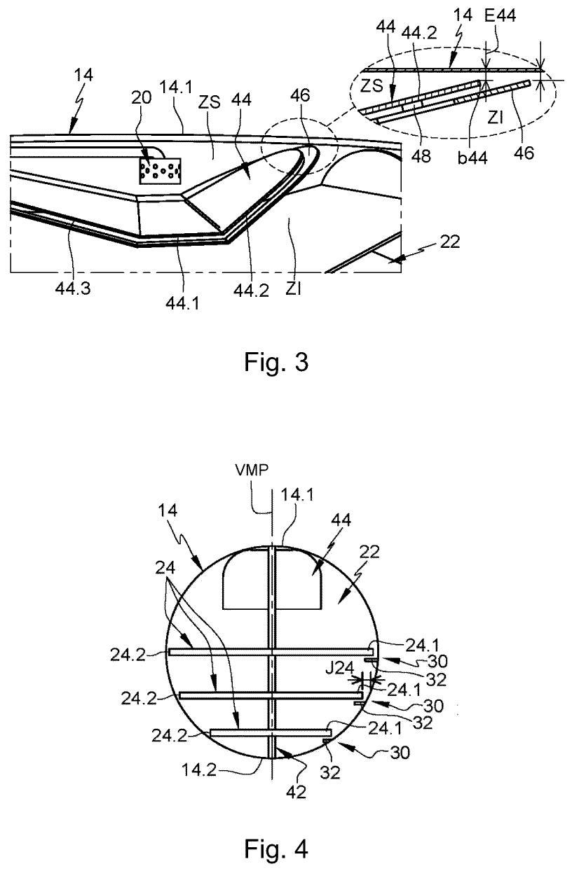

In an embodiment that can be seen in FIG. 3, the cryogenic tank 10 comprises a peripheral strip 46 that extends over at least a portion of the peripheral edge b44 of the partition 44 (preferably over the entire length of the peripheral edge b44 of the partition 44), substantially parallel to the partition and slightly spaced apart therefrom. In one configuration, the peripheral strip 46 is connected to the partition 44 by spacers 48 distributed along the peripheral edge b44 of the partition 44. In one arrangement, the peripheral strip 46 is offset toward the lower region ZI relative to the partition 44. This arrangement promotes circulation of a liquid from the upper region ZS toward the lower region ZI and makes circulation of liquid from the lower region ZI toward the upper region ZS more difficult.

The enclosure 14 and the anti-sloshing structure 22 may be made of the same material or of different materials.

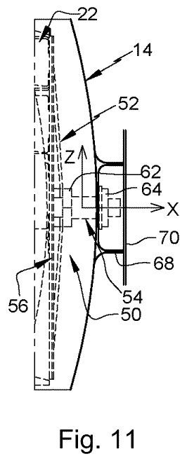

In an embodiment that can be seen in FIGS. 10 and 11, the cryogenic tank 10 comprises at least one connection system 50 connecting the enclosure 14 and the anti-sloshing structure 22. This connection system 50 is configured to allow movement of the anti-sloshing structure 22 relative to the enclosure 14 along a displacement direction DD parallel to the first direction X.

In one configuration, the connection system 50 comprises an elastically deformable element 52 which has a central portion 52.1 connected to the enclosure 14, a peripheral ring 52.2 connected to the anti-sloshing structure 22, and a plurality of radial blades 52.3 connecting the central portion 52.1 and the peripheral ring 52.2 and allowing the central portion 52.1 and the peripheral ring 52.2 to move relative to one another along a displacement direction DD.

The central portion 52.1 is a disk positioned in a transverse plane. The peripheral ring 52.2 is concentric with the central portion 52.1 and positioned in a transverse plane. The radial blades 52.3 are configured to allow movement along the displacement direction DD between the central portion 52.1 and the peripheral ring 52.2.

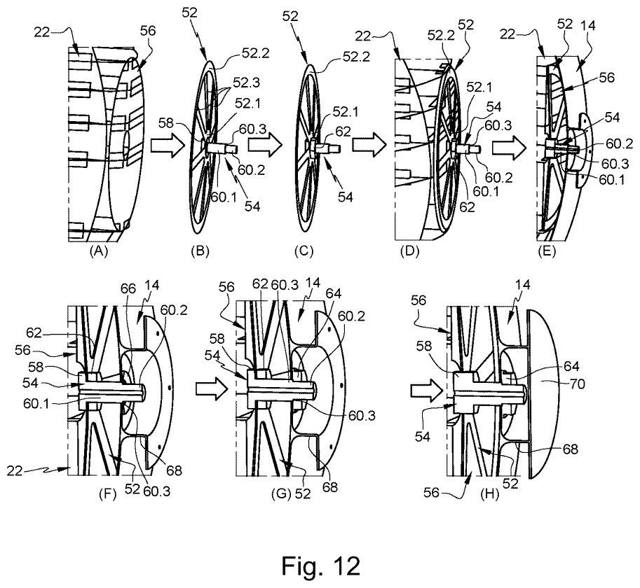

In one configuration, the connection system 50 comprises a longitudinal bolt 54 connecting the central portion 52.1 and the enclosure 14, and a transverse disk 56 (shown in part (A) of FIG. 12) connecting the peripheral ring 52.2 and the anti-sloshing structure 22.

In one embodiment, the longitudinal bolt 54 comprises a head 58 and a cylindrical body having first and second threaded sections 60.1, 60.2 connected by a shoulder 60.3, the first section 60.1 being connected to the head 58 and having a diameter greater than that of the second section 60.2. Additionally, the central portion 52.1 of the elastically deformable element 52 comprises an opening having a diameter substantially equal to, or slightly greater than, that of the first section 60.1. The enclosure 14 comprises an opening that has a diameter substantially equal to, or slightly greater than, that of the second section 60.2 and smaller than that of the first section 60.1.

According to an assembly method shown in FIG. 7, the transverse disk 56 is connected to the anti-sloshing structure 22, for example by welding. Next, the cylindrical body of the longitudinal bolt 54 is inserted into the opening in the central portion 52.1 until the head 58 bears against said central portion 52.1, as illustrated in part (B) in FIG. 12. The longitudinal bolt 54 is connected to the central portion 52.1 by means of a first nut 62, as illustrated in part (C) of FIG. 12. The peripheral ring 52.2 is then connected to the transverse disk 56, as illustrated in part (D) in FIG. 12, and the anti-sloshing structure 22 is introduced into the enclosure 14. At this stage, the longitudinal bolt 54 is inserted into the opening in the enclosure 14, as illustrated in part (E) of FIG. 12, and then connected to the latter by means of a second nut 64 with a washer 66 interposed between the second nut 64 and the enclosure 14, as illustrated in parts (F) and (G) of FIG. 12. As illustrated in parts (G) and (H), the enclosure 14 may have a boss 68 for housing the second section 60.2 of the longitudinal bolt 54 and the second nut 64, and a closure plate 70 for closing the boss 68.

Of course, the invention is not limited to this embodiment for the connection system 50.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A cryogenic tank comprising:
at least one enclosure containing a liquid phase and having a first orthogonal direction, a second orthogonal direction, and a third orthogonal direction, the third orthogonal direction being vertical;
at least one anti-sloshing structure positioned inside the at least one enclosure, the at least one anti-sloshing structure comprising a first plurality of walls and a second plurality of walls arranged so as to compartmentalize the at least one enclosure;
at least one connection system connecting the at least one anti-sloshing structure and the at least one enclosure; and
at least one piece of equipment dedicated to a gaseous phase,
wherein the anti-sloshing structure comprises at least one partition which, together with the at least one enclosure, defines an upper region in which the at least one piece of equipment is positioned,
the at least one partition comprising a central portion substantially perpendicular to the third orthogonal direction, and a first wing and a second wing each located a side of the central portion and form an angle of between 5° and 45° with a plane passing through the central portion.

2. The cryogenic tank of claim 1, wherein the at least one enclosure extends between an upper portion and a lower portion offset along the third orthogonal direction, and
wherein the first plurality of walls and the second plurality of walls are both arranged in such a manner as to define compartments having volumes that decrease toward the upper portion of the at least one enclosure.

3. The cryogenic tank of claim 1, wherein the first plurality of walls comprises at least four first walls that are substantially perpendicular to the third orthogonal direction.

4. The cryogenic tank of claim 1, wherein each wall of the first plurality of walls is symmetrical with respect to a vertical median plane, comprises lateral edges positioned on either side of the vertical median plane, and has a transverse profile which, at the vertical median plane, comprises a central region offset downward relative to the lateral edges.

5. The cryogenic tank of claim 1, wherein each wall of the first plurality of walls comprises at least one first through-opening, or a cut-out, or both to allow a flow of liquid from an upper portion toward a lower portion of the enclosure.

6. The cryogenic tank of claim 1, wherein the second plurality of walls comprises at least four second walls that are substantially perpendicular to the first orthogonal direction.

7. The cryogenic tank of claim 1, wherein at least one wall from the second plurality of walls comprises at least one through-opening.

8. The cryogenic tank of claim 1, wherein the at least one anti-sloshing structure comprises at least one third wall that is substantially perpendicular to the second orthogonal direction.

9. The cryogenic tank of claim 1, further comprising:
at least one sealing system interposed between a wall of the first plurality of walls and the at least one enclosure, limiting a fluid passage between the wall of the first plurality of walls and the at least one enclosure.

10. The cryogenic tank of claim 1, wherein the at least one partition has a peripheral edge that is spaced apart from the at least one enclosure by a clearance, and
wherein the cryogenic tank further comprises a peripheral strip that extends over at least a portion of the peripheral edge of the at least one partition, substantially parallel to the partition and spaced apart therefrom.

11. The cryogenic tank of claim 1, wherein the at least one connection system comprises an elastically deformable element which has a central portion connected to the at least one enclosure, a peripheral ring connected to the at least one anti-sloshing structure, and a plurality of radial blades connecting the central portion and the peripheral ring and allowing the central portion and the peripheral ring to move relative to one another along a displacement direction.

12. An aircraft comprising:
at least one cryogenic tank of claim 1.

13. A cryogenic tank comprising:
an enclosure containing a liquid phase and having a first orthogonal direction, a second orthogonal direction, and a third orthogonal direction, the third orthogonal direction being vertical;
an anti-sloshing structure positioned inside the enclosure, the anti-sloshing structure comprising a first plurality of walls and a second plurality of walls arranged in such a manner as to compartmentalize the enclosure; and
a connection system connecting the anti-sloshing structure and the enclosure,
wherein each wall of the first plurality of walls is symmetrical with respect to a vertical median plane, comprises lateral edges positioned on either side of the vertical median plane, and has a transverse profile which, at the vertical median plane, comprises a central region offset downward relative to the lateral edges.

14. The cryogenic tank of claim 13, wherein the enclosure extends between an upper portion and a lower portion offset along the third orthogonal direction, and
wherein the first plurality of walls and the second plurality of walls are arranged in such a manner as to define compartments having volumes that decrease toward the upper portion of the enclosure.

15. The cryogenic tank of claim 13, wherein the first plurality of walls comprises at least four first walls that are substantially perpendicular to the third orthogonal direction.

16. The cryogenic tank of claim 13, wherein each wall of the first plurality of walls comprises a through-opening, or a cut-out, or both to allow a flow of liquid from an upper portion toward a lower portion of the enclosure.

17. The cryogenic tank of claim 13, wherein the second plurality of walls comprises at least four second walls that are substantially perpendicular to the first orthogonal direction.

18. The cryogenic tank of claim 13, wherein at least one wall of the second plurality of walls comprises a through-opening.

19. The cryogenic tank of claim 13, wherein the anti-sloshing structure comprises a wall that is substantially perpendicular to the second orthogonal direction.

20. The cryogenic tank of claim 13, wherein the connection system comprises an elastically deformable element which has a central portion connected to the enclosure, a peripheral ring connected to the anti-sloshing structure, and a plurality of radial blades connecting the central portion and the peripheral ring and allowing the central portion and the peripheral ring to move relative to one another along a displacement direction.
